(19) United States
(12) Patent Application Publication
(10) Pub. No.: US 2014/0272164 A1
(43) Pub. Date: Sep. 18, 2014

(54) TUBE COATERS AND METHODS OF USING SAME

(71) Applicant: GENERAL ELECTRIC COMPANY, Schenectady, NY (US)

(72) Inventors: Kevin MCEVOY, Niskayuna, NY (US); Sean Michael SWEENEY, Niskayuna, NY (US); Ambarish KULKARNI, Niskayuna, NY (US)

(73) Assignee: GENERAL ELECTRIC COMPANY, Schenectady, NY (US)

(21) Appl. No.: 13/827,049

(22) Filed: Mar. 14, 2013

(51) Int. Cl. B05C 1/06

(52) U.S. Cl. CPC B05C 1/06
USPC 427/429; 118/264; 118/72

(57) ABSTRACT

The present application provides for coaters, and methods of using coaters, configured to coat tubes, rods or like members. The coaters may include a coating reservoir configured to apply a coating to the exterior surface of such members. The coating reservoir may include at least one void, first and second ends with first and second apertures, respectively, in communication with the at least one void, at least one port in communication with the at least one void, and coating delivery material positioned within the at least one void. The first aperture, second aperture, and coating delivery material may define a coating passageway through the coating reservoir. An engagement portion of the coating delivery material may define the narrowest portion of the coating pathway and be effective in supporting and coating the exterior surface of a member as the member passes, or is passed, through the coating passageway.

### BACKGROUND

The present application relates generally to mechanisms for applying a coating to a member, and more particularly to mechanisms and methods of using mechanism for coating elongate tubes, pipes, conduits, rods or any other like members.

It is often desirable, for a myriad of differing reasons, to cover the outer and/or inner surfaces of tubes and like members with a coating, such as a protective coating. For example, a tube or like member may be coated to provide, at least in part, corrosion resistance, scratch resistance, impact strength, mechanical wear resistance, or combinations thereof. Complete and uniform application of the coating delivery material or substance to the outer (and/or inner) surface of tubes and like members is often desirable or required depending upon the particular coating and/or the application of the tubes.

Coating tubes and like members with liquid-based coating materials or substances utilizing prior art techniques encounters several problems associated with providing complete and uniform coverage of the coating. Specifically, while dip coating mechanisms and methods may be effective in providing relatively complete and uniform coverage of liquid-based coatings to tubes and like members, substantially long tubes typically require a substantially high ceiling (or otherwise a large footprint) in the building in which the tubes are coated for a vertical dip process. Brush coating, on the other hand, typically requires a relatively smaller footprint as compared to dip coating. However, brush coating mechanisms and methods commonly result in a particularly non-uniform liquid-based coating (e.g., thicker and thinner areas of the coating material), may fail to provide complete coating coverage, and tend to be time consuming and labor intensive. Similarly, while spray coating mechanisms and methods typically require a relatively smaller footprint as compared to dip coating and commonly provide a relatively more complete and uniform liquid-based coating coverage as compared to brush coating mechanisms and methods, spray coating is time consuming, labor intensive, includes negative environmental repercussions, and results in a significant amount of lost or wasted coating material due to over-spray.

Accordingly, it would be desirable to reduce or substantially eliminate the disadvantages of prior liquid-based tube coating mechanisms and methods. Such improved tube coating mechanisms and methods should provide for a more substantially uniform liquid-based coating to the outer (and/or inner) surface of tubes and like members in a cost-effective manner. Such improved liquid-based tube coating mechanisms and methods should reduce costs by, for example, reducing coating process requirements (e.g., time, material or labor) and/or the required footprint as compared to prior liquid-based tube coating mechanisms and methods.

### BRIEF DESCRIPTION

In accordance with one aspect of the present disclosure, a coating mechanism for applying a coating to the exterior surface of an elongate member is disclosed. In some embodiments, the coating mechanism includes a coating reservoir and at least one support mechanism operably coupled to the coating reservoir. In some embodiments, the coating reservoir includes a first end with a first aperture, a second end with a second aperture, at least one void extending between the first and second ends and about the first and second apertures, at least one port in communication with the at least one void, and coating delivery material positioned within the at least one void. In some embodiments, the first aperture, the second aperture and the coating delivery material define a coating passageway through the coating reservoir. In some embodiments, an engagement portion of the coating delivery material defines the narrowest portion of the coating passageway. In some embodiments, at least one of the coating delivery material and the at least one support mechanism is configured to support an elongate member such that when the elongate member extends through the coating passageway a portion of the exterior surface of the elongate member is in contact with the engagement portion of the coating delivery material and the exterior surface of the elongate member is not in contact with at least the second aperture of the coating reservoir.

In accordance with another aspect of the present disclosure, a coater for applying a coating to the exterior surface of at least a tube or rod of a first diameter is disclosed. In some embodiments, the coater includes a coating reservoir, at least one support mechanism operably coupled to the coating reservoir, and at least one drive mechanism. In some embodiments, the coating reservoir includes a first end with a first aperture including a second diameter that is larger than a first diameter of a tube or rod, a second end with a second aperture including a third diameter that is larger than the first diameter of the tube or rod, at least one port, at least one void extending between the first and second ends and about the first and second apertures, the at least one void in communication with the first aperture, the second aperture and the at least one port, and coating delivery material positioned within the at least one void. In some embodiments, the coating delivery material is permeable by a coating. In some embodiments, the first aperture, the second aperture and the coating delivery material define a coating passageway through the coating reservoir, and an engagement portion of the coating delivery material defines the narrowest portion of the coating passageway. In some embodiments, the at least one drive mechanism is configured to translate at least one of the coater and the tube or rod with respect to the other to apply the coating to the exterior surface of the tube or rod when the tube or rod extends through the coating passageway in a coating direction extending at least generally from the second aperture to the first aperture of the coating reservoir. In some embodiments, at least one of the coating delivery material and the at least one support mechanism is configured to support the tube or rod such that when the tube or rod extends through the passageway a portion of the exterior surface of the tube or rod is in contact with the engagement portion of the coating delivery material and not in contact with at least the second aperture of the coating reservoir.

In accordance with another aspect of the present disclosure, a method of applying a coating to the exterior surface of an elongate member is disclosed. In some embodiments, the method includes obtaining a coating mechanism comprising a coating reservoir and at least one support mechanism operably coupled to the coating reservoir. In some embodiments, the coating reservoir includes a first end with a first aperture, a second end with a second aperture, at least one void extending between the first and second ends and about the first and second apertures, at least one port in communication with the at least one void, and coating delivery material positioned within the at least one void. In some embodiments, the first aperture, the second aperture and the coating delivery material define a coating passageway through the coating reservoir, and an engagement portion of the coating delivery material defines the narrowest portion of the coating passageway. In some embodiments, the method includes obtaining an elongate member, and positioning at least one of the elongate member and the coating mechanism such that the elongate member extends through the coating passageway.

These and other objects, features and advantages of this disclosure will become apparent from the following detailed description of the various aspects of the disclosure taken in conjunction with the accompanying drawings.

### BRIEF DESCRIPTION OF THE DRAWINGS

FIG. 1 is a cross-sectional view of a first illustrative tube or rod coater embodiment; and

FIG. 2 is an enlarged, partial cross-sectional view of the coating mechanism portion of the illustrative tube or rod coater embodiment of FIG. 1.

### DETAILED DESCRIPTION

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments. Components, aspects, features, configurations, arrangements, uses and the like described, illustrated or otherwise disclosed herein with respect to any particular embodiment may similarly be applied to any other embodiment disclosed herein.

FIGS. 1 and 2 illustrate an illustrative tube coating mechanism generally indicated by the reference numeral 10. The illustrative tube or rod coating mechanism 10, or simply the coater 10, may be effective in applying a coating (e.g., a liquid-based coating) to one or more surface of a tube, pipe, cylinder, conduit, rod or other similarly shaped member 12, as shown in FIGS. 1 and 2. The tube or rod 12 coated by the coater 10 may or may not be substantially symmetrically shaped (i.e., include a substantially circular or symmetrical cross-section) or be hollow, as illustrated. As described further below, aspects of the illustrative coating mechanism 10 (e.g., the shape and/or size of the openings 24, 26 of the reservoir member 18) may mimic, relate or correspond (at least partially) to aspects of the tube or rod 12 coated by the coater 10 (e.g., the shape and/or size of outer surface 16 thereof). In this way, the illustrative coating mechanism 10 may be altered or otherwise adapted to suit a particular tube, rod or member 12 to provide a substantially uniform coating to the particular member 12. Such alternations or adaptations are specifically contemplated herein and thereby any disclosure herein relating to the size, shape, or other geometry or aspects of the illustrative illustrated tube, rod, or member 12, and thereby the corresponding geometry or aspects of the illustrated tube coater 10, are not meant in a limiting sense and are merely illustrative.

The illustrative tube 12 shown in FIGS. 1 and 2 is substantially cylindrical (i.e., includes a substantially circular cross-section), hollow and elongate. Stated differently, the illustrative tube or rod 12 includes an outer wall 14 formed about an elongate or longitudinal axis X-X forming a substantially annular outer surface 16. The particular length of the illustrative tube or rod 12 along the axis X-X may vary, but may be substantially longer than the corresponding length of the tube coater 10. It is noted that the shape and/or size of the outer surface 16 of the illustrative tube or rod 12 may vary along its axial length, such as due to manufacturing tolerances. For example, the outer surface 16 of the illustrative tube or rod 12 may include or define peaks and valleys, bends, surface imperfections or other variations and the like. While these imperfections or variations may have at least some effect on the uniformity of the coating applied to a tube or rod 12 via the illustrative tube coater 10, their effect may be relatively minor such that the uniformity and coverage of the liquid-based coating applied by the illustrative tube coater 10 is at least as good as, or better than, that of prior art coating mechanism and methods utilizing a similar liquid-based coating. Also, it is again noted that the illustrative tube or rod 12 is an example of a member that may be coated by the illustrative coater 10 (and alternative embodiments thereof), and other members that differ from illustrative tube or rod 12 may be coated by the illustrative coater 10 (and alternative embodiments thereof).

Similar to the particular tube or member 12 coated by the illustrative coater 10, the particular coating medium or material utilized by the coater 10 may vary. In some embodiments, the illustrative coater 10 may be particularly suited or advantageous for use with liquid-based coatings. For example, the illustrative coater 10 may be effective in applying or depositing a layer on the outer surface or diameter of a tube or rod 12 of a liquid or a suspension of particles in liquid. In some such embodiments, once the layer of liquid or liquid-based material or substance, for example, is left to dry, cure, setup, be further processed or the like, the applied or deposited layer may form a coating from what was dissolved, suspended or the like in the layer. However, in at least some embodiments the illustrative coater 10 may utilize non-liquid or non-liquid based coating materials or substances. In some embodiments, the coating medium may be a liquid-based hydrophobic precursor, such as a liquid-based hydrophobic precursor of U.S. patent application Ser. No. 13/282,175 (discussed further below).

As shown in FIGS. 1 and 2, the illustrated illustrative coater 10 includes an annular reservoir 18 that substantially surrounds a portion of the exterior surface of a tube or member 12. The reservoir 18 may define or include a first member, portion, or end 20, and a second member, portion, or end 22 spaced longitudinally from one another, as also shown in FIGS. 1 and 2. The first end 20 may include a first aperture or opening 24, and the second end 22 may include a second aperture or opening 26. The first and second apertures 24, 26 may or may not define a substantially similar shape. In the illustrative embodiment shown in FIGS. 1 and 2 the first and second apertures 24, 26 are substantially circular, but the diameter of the first aperture is less than the diameter of the second aperture 26. In some embodiments, such as the illustrated embodiments shown in FIGS. 1 and 2, the first and second apertures 24, 26 may be substantially centered or aligned, such as centered or aligned along an axis, such as the longitudinal axis X-X of a tube or rod 12 extending through the first and second apertures 24, 26.

The reservoir 18 may also define or include an annular or other-shaped void or space 28 extending between the first and second ends 20, 22 and about the first and second apertures 24, 26, at least partially. In this way the at least one void 28 is in communication with the first and second apertures 24, 26 of the first and second ends 20, 22. In some embodiments, the reservoir 18 may define or include a single void 28 extending substantially about the first and second apertures 24, 26, such as the annular void 28 shown in FIGS. 1 and 2. In some alternative embodiments (not shown), the reservoir 18 may define or include two or more voids 28 that, collectively, extend substantially about the first and second apertures 24, 26. The combination of the first and second apertures 24, 26 of the first and second ends 20, 22 and the one or more void 28 of the reservoir 18 may allow a tube or rod 12 to pass completely through the reservoir 18. In such an embodiment, as shown in FIGS. 1 and 2, the tube or rod 12 may pass through the first and second apertures 24, 26 of the first and second ends 20, 22 such that the entirety, or at least a substantial portion, of the exterior surface 16 of the tube or rod 12 extending between the first and second ends 20, 22 is exposed to the one or more void 28 of the reservoir 18.

As shown in FIGS. 1 and 2, the reservoir 18 may define or include one or more ports, channels or pathways 30 that extend from the exterior of the reservoir 18 and into the at least one void 28. The at least one port 30 may allow for or provide a passageway for the coating medium, substance or material to penetrate into the at least one void 28, as shown by the arrows 31 in FIGS. 1 and 2. The at least one port 30 may also be effective in coupling to a feed line 32 to provide a flow path for the coating medium to flow to the at least one port 30, as shown by the arrows 31 in FIGS. 1 and 2. In some embodiments, the coater 10 may include one or more pump 33 effective in pumping the coating medium into the void 28 of the reservoir 18 via the at least one port 30 (e.g., through one or more tube). If multiple voids 28 are included, each void 28 may include a port 30. Similarly, in some embodiments the reservoir 18 may include or define two or more ports 30 spaced or arranged about the first and second apertures 24, 26 such that the coating medium penetrates the at least one void 28 from differing sides or positions, as shown in FIGS. 1 and 2. In some embodiments including multiple ports 30, the ports 30 may be spaced substantially symmetrically about the at least one void 28 and/or the first and second apertures 24, 26 such that they are spaced substantially symmetrically about the exterior surface 16 of a tube or rod 12 extending through the reservoir 18 (e.g., spaced substantially symmetrically about the longitudinal axis X-X).

As also shown in FIGS. 1 and 2, the coater 10 may include coating delivery material 40 disposed at least partially within the at least one void 28 of the reservoir 18. The coating delivery material 40 may generally extend between the first and second ends 20, 22 and at least partially about the first and second apertures 24, 26. In some embodiments, the coating delivery material 40 may extend substantially about the first and second apertures 24, 26, such as within the annular void 28 shown in FIGS. 1 and 2. The coating delivery material 40 may be configured such that when a tube or rod 12 is positioned through the reservoir 18 via the first and second apertures 24, 26 of the first and second ends 20, 22, the entirety, or at least a substantial portion, of the circumference or perimeter of the exterior surface 16 of the tube or rod 12 is in contact with the coating delivery material 40.

In some embodiments, as shown in FIG. 2, the coating delivery material 40 may be positioned within the at least one void 28. The coating delivery material 40 may extend within the at least one void 28 of the reservoir 18 and generally about the first and second apertures 24, 26 (e.g., the center or axis of the first and second apertures 24, 26) a length L2 along at least a portion of the longitudinal length of the reservoir 18 such that engagement portions 44 of the coating delivery material 40 extend, at least slightly, past the interior edges of the first and second apertures 24, 26 toward the center or interior of the reservoir 18. In this way, as shown in FIG. 2, the first aperture 24 of the first end 20, the second aperture 26 of the second end 22 and the coating delivery material 40 define, at least in part, a coating passageway through the coating reservoir that defines a length L3. The coating passageway thereby represents the space or area within the reservoir 18 through which a member (e.g., tube or rod 12) can pass to be coated by the coater 10. The interior edges or surfaces of the first and second apertures 24, 26 and the interior surface of the engagement portion(s) 44 of the coating delivery material 40 may define the edges or boundary of the coating passageway. As the engagement portions 44 of the coating delivery material 40 extend, at least slightly, past the interior edges of the first and second apertures 24, 26 toward the center or interior of the reservoir 18 of the illustrative coater 10, the engagement portion(s) 44 of the coating delivery material 40 may define the narrowest portion of the coating passageway. In this way, a tube or rod 12 of a lesser size or diameter than that of the first and second apertures 24, 26, for example, may be positioned through the coating passageway of the reservoir 18 (via the first and second apertures 24, 26 and coating delivery material 40 in the at least one void 28) such that a portion of the outer surface 16 of the tube or rod 12 is in contact with the engagement portions 44 of the coating delivery material 40 and not the edges or surfaces of the first and/or second apertures 24, 26. In such embodiments, the relative size and/or shape of the first and second apertures 24, 26, the positioning or arrangement of the engagement portions 44 of the coating delivery material 40, and the relative size and/or shape of the particular tube or rod 12 being coated may be proportional, dependent or otherwise related such that the engagement portions 44 of the coating delivery material 40 engages the outer surface 16 of the tube or rod 12 and not the edges or surfaces of the first and/or second apertures 24, 26.

In some embodiments, the coating delivery material 40 may be effective in supporting the coater 10, at least partially, over a tube or rod 12 (or the tube or rod 12 within the coater 10) such that the engagement portions 44 of the coating delivery material 40 engages the outer surface 16 of the tube or rod 12 and not the edges or surfaces of the first and/or second apertures 24, 26. For example, the coating delivery material 40 may be sufficiently stiff or resistive such that the coater 10 is prevented, at least partially, from shifting or orienting in a position or orientation (e.g., due to the weight of the coater 10 or the tube or rod 12 being coated) such that the edges or surfaces of the first and/or second apertures 24, 26 contacts the outer surface 16 of the tube or rod 12. As explained further below, the tube coater 12 may include one or more support mechanism to aid in supporting a tube or rod 12 through the reservoir 18 such that the edges or surfaces of the first and/or second apertures 24, 26 are prevented from contacting the outer surface 16 of the tube or rod 12.

The coating delivery material 40 may be effective in applying the coating medium or substance to the tube or rod 12 being coated by the coater 10, such as to the outer surface 16 of the tube or rod 12 passing through (or being passed over by) the coater 10, as shown in FIGS. 1 and 2. Specifically, the coating delivery material 40 may be permeable to the coating medium or substance such that as the coating medium or substance is transferred into the at least one void 28 of the reservoir 18 the coating medium passes through the coating delivery material 40 and is deposited onto the tube or rod 12 via the engagement portions 44 thereof interacting with the tube or rod 12. For example, the coating delivery material 40 may include a wicking or capillary action propensity or quality such that it tends to draw coating medium or substance present in the at least one void 28 of the reservoir 18 into the coating delivery material 40 and onto the tube or rod 12 via the engagement portions 44 thereof. The rate or quantity at which the coating delivery material 40 applies coating medium or substance onto the tube or rod 12 may depend upon numerous factors, including the natural wicking propensity and/or other properties of the coating delivery material 40 with respect to the particular coating medium, the properties of the particular coating medium, the speed at which the tube or rod 12 passes through (or is passed over by) the coater 10, the rate at which the coating medium or substance is transferred into the reservoir 18 (e.g., pumped under pressure), the spacing between the exterior surface 16 of the tube or rod 12 and the edge or surface of the first and/or second apertures 24, 26, the longitudinal length L2 of the engagement portions 44 of the coating delivery material 40, or combinations thereof. In some embodiments, the longitudinal length L2 of the engagement portions 44 of the coating delivery material 40 may be about 5 cm.

In some embodiments, the coating delivery material 40 may include a synthetic absorbent material, such as a polyether, poly-vinyl alcohol, polyester, or other plastic material. In some embodiments, the coating delivery material 40 may include a natural material, such cotton or wool fibers/textures (e.g., a felt), or cellulose wood fibers/textures. In some embodiments, the coating delivery material 40 may be any material or composition that is an effective vehicle for delivering and depositing the coating or film material and is sufficiently dense, firm, stiff, strong or the like to support or guide a tube or rod 12 as it travels through the reservoir 18. For example, the coating delivery material 40 may be any material or composition that that is effective in supporting or guiding a tube or rod 12 as it travels through the reservoir 18 such that the tube or rod 12 does not interact with the edges or surfaces of the first and second apertures 24, 26. In some embodiments, the coating delivery material 40 may be substantially resistant to deterioration or degradation by solvents, such as but not limited to alcohols or ketones.

As noted above, the relative size and/or shape of the first and/or second apertures 24, 26 and the exterior surface 16 of a tube or rod 12 being coated by the coater 10 may determine, at least in part, the amount (e.g., thickness) or other arrangement/characteristics of the coating medium that is applied to the exterior surface 16 of the tube or rod 12. For example, as shown in FIG. 2, in some embodiments a tube or rod 12 may be inserted into the reservoir 18 and the coater 10 may be translated in a first longitudinal direction 46 and/or the tube or rod 12 may be translated in a second longitudinal direction 48 opposing the second longitudinal direction 46 such that the tube or rod 12 travels through the reservoir 18 and along the engagement portions 44 of the coating delivery material 40 from the first end 20 of the reservoir 18 to the second end 22 of the reservoir 18. Stated differently, the coater 10 may apply the coating medium in a coating direction extending, at least generally, from the second aperture 26 of the second end 22 to the first aperture 24 of the first end 20. In such an embodiment, the engagement portions 44 of the coating delivery material 40 may deposit the coating medium on the exterior surface 16 of the tube or rod 12 and the gap between the interior surface(s) or edge(s) of the second aperture 26 of the second end 22 and the exterior surface 16 of the tube or rod 12 may thereby form an exit passageway for the applied coating material 50. In such illustrative embodiments, an interior edge 42 of the second aperture 26 of the second end 22 may effectively act as a doctor blade. The second aperture 26 of the second end 22 and the exterior surface 16 of the tube or rod 12 may thereby provide the exit passageway through which the coating medium can pass and thus be deposited as a layer of coating material 50 on the tube or rod 12. In this way, the configuration of the second aperture 26 of the second end 22 and the exterior surface 16 of the tube or rod 12 may control the thickness of the applied coating material 50 left behind on the tube or rod 12 as the coater 10 passes over the tube or rod 12 (and/or the tube or rod 12 passes through the coater 10). For example, in the illustrative embodiment shown in FIGS. 1 and 2 the tube or rod 12 includes a circular outer surface 16 and the second aperture 26 of the second end 22 of the reservoir 18 of the coater 10 is also circular, and therefore the exit passageway is an annular exit passageway extending about the tube or rod 12 and defines the thickness of the coating medium applied 50 to the exterior surface 16 of the tube or rod 12 by the coater 10. In some embodiments, the second aperture 26 of the second end 22 of the reservoir 18 of the coater 10 may be configured with respect to a particular tube or rod 12 such that the applied coating material 50 defines a thickness of about 200 nanometers to about 10 microns. In some such embodiments, the about 200 nanometers to about 10 microns thick applied coating material 50 on the tube or rod 12 deposited by the coater 10 may be substantially planar or smooth and uniform due to the configuration of the coater 10. In some embodiments, the second aperture 26 of the second end 22 of the reservoir 18 of the coater 10 may be configured with respect to a particular tube or rod 12 such that the applied coating material 50 defines a thickness of about 3 millimeters (e.g., about ⅛ inch).

As described above, the applied coating material 50 on the tube or rod 12 may be left to dry, cure, setup or the like and ultimately form a coating (such as a coating formed from what was dissolved/suspended in a liquid-based coating medium applied on the tube or rod 12). In some embodiments, the longitudinal length L1 of the second aperture 26 of the second end 22 of the reservoir 18 may be selected or configured to control, at least partially, the drying, curing, setting up or the like of the applied coating material 50. For example, the longitudinal length L1 of the second aperture 26 of the second end 22 of the reservoir 18 may be selected or configured along with, or in consideration of, the coating speed of the coater 10 and/or the flow rate of coating material 50 into the reservoir 18 such that the second aperture 26 substantially prevents the applied coating material 50 from interacting with the surrounding environment (e.g., air) for a predetermined amount of time. During this predetermined amount of time, and potentially any inherent “drying” time thereafter, the newly applied coating material 50 is able to settle, flow, smooth, spread-out or otherwise substantially uniformly coat the portion of the tube or rod 12 to which the coating material 50 is applied. In such a way the longitudinal length L1 of the second aperture 26 of the second end 22 of the reservoir 18 may be effective in controlling (e.g., lengthening) the “drying” time of the applied coating material 50 to ensure a substantially uniform coating.

The longitudinal length L1 of the second aperture 26 (i.e., the length of the exit channel or gap) sufficient to provide the newly applied coating material 50 suitable “drying” time may depend upon, or at least be related to, the particular coating substance, the rate of movement between the reservoir 18 and the tube or rod 12, the thickness of the exit channel or gap, environmental conditions, the size of the tube or rod 12 being coated, etc. For example, a coater 10 embodiment operating at a relatively slow coating speed, with a relatively high flow rate of coating material 50 into the reservoir 18 (and thereby into the coating delivery material 40) would deposit a relatively thick “wet” coating which would tend to dry relatively slowly and therefore require a relatively short second aperture 26 (i.e., the length of the exit channel or gap) to ensure a substantially uniformly “dried” coating. In comparison, a coater 10 embodiment operating at a relatively fast coating speed, with a relatively low flow rate of coating material 50 into the reservoir 18 (and thereby into the coating delivery material 40) would deposit a relatively thin “wet” coating which would tend to dry relatively quickly and therefore require a relatively long second aperture 26 (i.e., the length of the exit channel or gap) to ensure a substantially uniformly “dried” coating.

For example, in some illustrative non-limiting embodiments the coating substance may be a liquid-based hydrophobic precursor, the tube or rod 12 being coated may be within the range of about 0.6 centimeters to about 5 centimeters in diameter, the rate of movement between the reservoir 18 and the tube or rod 12 may be within the range of about 0.1 millimeter per second and about 250 millimeters per second, the thickness of the exit channel or gap may be between about 0.45 centimeters and about 0.6 centimeters, and the longitudinal length L1 of the second aperture 26 (i.e., the longitudinal length of the exit channel or gap) may be up to about 0.7 centimeters.

In one illustrative embodiment, the coating medium may be a super-hydrophobic coating, such a coating of U.S. patent application Ser. No. 13/282,175. For example, the coating medium may be a hydrophobic coating for heat transfer enhancement in steam condensers. In some such embodiments, the hydrophobic coating may be a formulation of about 4 molar % Fluoro-silane Zirconia. In some embodiments, the coating medium may be Zr:F:Si precursor dissolved in a mixture of Butanol:Cyclohexanol for enhanced phase change heat transfer. In some embodiments, the coater 10 has been found effective in coating about 1.6 centimeter diameter tubes or rods 12 of about 0.9 meters in length, as well as about 2.5 centimeter diameter tubes or rods 12 of about 1.5 meters in length. In some embodiments, the coater 10 has been found effective in coating such tubes or rods 12 with an applied coating material 50 (such as after curing, drying or the like) with uniform contact angles greater than about 105, hysteresis of at least about 40 deg, and drop-wise steam condensation characteristics. Such tubes or rods 12 were coated with a feed or coating rate of about 0.1 millimeter per second to about 100 millimeters per second.

In one illustrative experimental configuration of the coater 10, a tube or rod 12 of about 2.54 centimeters in diameter and about 1.5 meters in length was coated at a speed of 20 millimeters per second, the flow rate of the coating medium into the reservoir 18 was about 1 liter per hour, the coating delivery material 40 was a cotton felt medical grade density pad of about 1.3 centimeters in length L2, the length L3 of the reservoir 18 was about 2.5 centimeters in length, the diameter of the first and second apertures 24, 26 of the first and second ends 20, 22 was about 3 centimeters, the applied coating 50 was about 800 nanometers thick, the coater 10 included a coating treatment mechanism 76 (see FIG. 1) in the form of a heater of about 20 centimeters in length at a temperature of about 250 degrees Celsius. In some embodiments, the coater 10 was effective in coating such tubes or rods 12 with an applied coating material 50 with uniform water contact angles greater than about 105 degrees, hysteresis of at least about 40 degrees, and dropwise steam condensation characteristics.

As shown in FIG. 1, the coater 10 may include one or more support mechanism 70 operably coupled to the reservoir 18. The at least one support mechanism 70 may be any mechanism effective in supporting the reservoir 18 with respect to a tube or rod 12 being coated by the coater 10. For example, the coater 10 may include at least one support mechanism 70 proximate at least one of the first and second ends 20, 22 of the reservoir 18. In some embodiments, the coater 10 may include at least one support mechanism 70 proximate both the first and second ends 20, 22 of the reservoir 18. In some embodiments, the at least one support mechanism 70 may be incorporated, at least partially, into or with at least one of the first and/or second apertures 24, 26 of the first and second ends 20, 22 of the reservoir 18. The at least one support mechanism 70 may also be effective in supporting a tube or rod 12 being coated by the coater 10 within the first and/or second apertures 24, 26 such that the outer surface 16 of the tube or rod 12 does not come into contact with the edges or surfaces of the first and/or second apertures 24, 26. For example, the at least one support mechanism 70 may include at least one support wheel, O-ring, guide ring (e.g., Teflon® guide ring) or any other mechanism capable of translating over, in or on the tube or rod 12 being coated configured such that the reservoir 18 is substantially fixed in relation to the tube or rod 12. In this way, the at least one support mechanism 70 may guide the reservoir 18 along the longitudinal length of the tube or rod 12 to being coated in a predetermined, relatively fixed orientation or position with respect to the tube or rod 12.

As also shown in FIG. 1, the coater 10 may include a cleaning or preparation mechanism 74. The cleaning mechanism 74 may be any mechanism capable of cleaning, preparing, treating or otherwise readying the surface of the tube or rod 12 that is to be coated by the coater 10. The coater 10 may thereby provide both cleaning and coating processes during a single pass of the coater 10 about a tube or rod 12. For example, the cleaning mechanism 74 may include a cleaning substance or material that removes contaminates from the exterior surface 16 of the tube or rod 12 before it is coated so that the applied coating material 50 is deposited directly to the exterior surface 16 of the tube or rod 12 (rather than to any contaminates present on the tube or rod 12), as shown in FIG. 1. The cleaning mechanism 74 may be positioned proximate at least one of the first and second ends 20, 22 of the reservoir 18, and may be positioned on either longitudinal side of the at least one support mechanism 70 (if present).

In some embodiments the coater 10 may include at least one coating treatment mechanism 76 as shown in FIG. 1. The coating treatment mechanism 76 may be any mechanism capable of effecting or controlling, at least partially, the drying, curing, setting up or the like of the applied coating material 50. The coater 10 may thereby provide cleaning, coating and coating treatment processes during a single pass of the coater 10 about a tube or rod 12. For example, the coating treatment mechanism 76 may include a heater (e.g., inductive heater or infrared heater), a radiation source—such as an ultraviolet lamp—for use where, for example, curing by electromagnetic radiation is desired, and/or fan or blower positioned proximate the second end 22 of the reservoir 18 such that the coating treatment mechanism 76 performs some type of treatment to the applied coating material 50 after (e.g., after some period of time) the applied coating material 50 exits the second aperture 26 (i.e., the exit channel or gap), as shown in FIG. 1. In some embodiments, the coating treatment mechanism 76 may define a treatment zone defining a length of about 13 centimeters. The coating treatment mechanism 76 may be positioned proximate at least one of the first and second ends 20, 22 of the reservoir 18, and may be positioned on either longitudinal side of at least one support mechanism 70 (if present).

In some embodiments, the coater 10 may include at least one cleaning mechanism 74 positioned at a first longitudinal end of the coater 10, at least one first support mechanism 70 adjacent the at least one cleaning mechanism 74, at least one reservoir 18 adjacent the at least one first support mechanism 70, at least one coating treatment mechanism 76 adjacent the at least one reservoir 18 and at least one second support mechanism 70 adjacent the at least one coating treatment mechanism 76 and positioned at a second longitudinal end of the coater 10 opposing the first end thereof. In some such embodiments, the coater 10 may be configured to coat a tube or rod 12 by traveling with respect to the tube or rod 12 in a first longitudinal direction 46 extending from the second longitudinal end of the coater 10 to the first longitudinal end thereof (and/or the tube or rod 12 traveling with respect to the coater 10 in a second longitudinal direction 48 substantially opposing the first longitudinal direction 46).

As mentioned above, in some embodiments the coater 10 may be configured such that the coater 10 is configured to translate or travel with respect to the tube or rod 12 in which it is coating. As also mentioned above, the to-be-coated tube or rod 12 may be configured such that the tube or rod 12 is configured to translate or travel with respect to the coater 10. Regardless of whether the coater 10 itself, the tube or rod 12 or the both the coater 10 and tube or rod 12 are configured to translate with respect to the other component, the coater 10 may include at least one drive mechanism 80 such that the tube or rod 12 is coated in the coating direction. The at least one drive mechanism 80 may be any drive mechanism effective in translating at least one of the coater 10 and tube or rod 12 with respect to each other such that the tube or rod 12 is coated in the coating direction. For example, the at least drive mechanism 80 may include a frame and motor configured (e.g., computer controlled) to translate the coater 10 over a tube or rod 12 at predefined speed or velocity. In some embodiments, the at least one drive mechanism 80 may be configured to translate the coater 10 over a tube or rod 12 at about 24 cm/s. The at least one drive mechanism 80 may be configured to translate the coater 10 (e.g., the reservoir 18 and/or exit passageway thereof) with respect to the entire longitudinal length of a particular tube or rod 12 or only a portion of the length of the tube or rod 12. For example, in some embodiments at least two coaters 10, 10 may be used to coat a particular tube or rod 12 and the at least two coaters 10 may be controlled by the at least one drive mechanism 80 to translate from a medial portion to opposing ends of the tube or rod 12 to substantially coat the entirety of the tube or rod 12 (i.e., each coater 10 being effective in coating about one half the tube or rod 12).

The above description is intended to be illustrative, and not restrictive. Numerous changes and modifications may be made herein by one of ordinary skill in the art without departing from the general spirit and scope of the invention as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely illustrative. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Also, the term “operably coupled” is used herein to refer to both connections resulting from separate, distinct components being directly or indirectly coupled and components being integrally formed (i.e., monolithic). Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure. It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the disclosure may include only some of the described embodiments. Accordingly, the invention is not to be seen as limited by the foregoing description, but is only limited by the scope of the appended claims.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A coating mechanism for applying a coating to the exterior surface of an elongate member, the coating mechanism comprising:
a coating reservoir including:
a first end with a first aperture;
a second end with a second aperture;
at least one void extending between the first and second ends and about the first and second apertures;
at least one port in communication with the at least one void; and
coating delivery material positioned within the at least one void,
wherein the first aperture, the second aperture and the coating delivery material define a coating passageway through the coating reservoir, and wherein an engagement portion of the coating delivery material defines the narrowest portion of the coating passageway; and
at least one support mechanism operably coupled to the coating reservoir,
wherein at least one of the coating delivery material and the at least one support mechanism is configured to support an elongate member such that when the elongate member extends through the coating passageway a portion of the exterior surface of the elongate member is in contact with the engagement portion of the coating delivery material and the exterior surface of the elongate member is not in contact with at least the second aperture of the coating reservoir.

2. The coating mechanism of claim 1, wherein the coating delivery material is permeable to a liquid-based coating medium.

3. The coating mechanism of claim 2, wherein the coating delivery material comprises a felt material.

4. The coating mechanism of claim 1, wherein the coating mechanism includes a drive mechanism configured to translate at least one of the coating mechanism and the elongate member such that the coating mechanism applies a coating to the exterior surface of the elongate member in a coating direction extending at least generally from the second aperture to the first aperture of the coating reservoir.

5. The coating mechanism of claim 4, wherein the elongate member is a tube or rod and the exterior surface thereof includes a first outer diameter, and wherein the second aperture of the coating reservoir includes an inner surface that defines a first inner diameter that is greater than the first outer diameter of the tube or rod.

6. The coating mechanism of claim 5, wherein when the tube or rod extends through the coating passageway a portion of the outer surface of the tube or rod and the inner surface of the second aperture of the coating reservoir define an exit passageway about the tube or rod that substantially defines the thickness of the coating applied to the exterior surface of the tube or rod by the tube coater.

7. The coating mechanism of claim 6, wherein at least the length of the exit passageway in the coating direction and the drive mechanism are configured such that the coating applied to the exterior surface of the tube or rod is substantially prevented from being exposed to the environment present about the coating mechanism for a predetermined amount of time effective in allowing the applied coating to flow and substantially uniformly cover the exterior surface of the tube or rod.

8. The coating mechanism of claim 1, wherein the coating mechanism includes at least one of:
a cleaning mechanism configured to clean the elongate member before the coating is applied to the exterior surface of the elongate member;
a coating treatment mechanism configured to treat at least one of the elongate member and the coating applied to the exterior surface of the elongate member; and
a drive mechanism for translating at least one of the elongate member and the coating mechanism with respect to the other.

9. A coater for applying a coating to the exterior surface of at least a tube or rod of a first diameter, the coater including:
a coating reservoir including:
a first end with a first aperture including a second diameter that is larger than a first diameter of a tube or rod;
a second end with a second aperture including a third diameter that is larger than the first diameter of the tube or rod;
at least one port;
at least one void extending between the first and second ends and about the first and second apertures, the at least one void in communication with the first aperture, the second aperture and the at least one port; and
coating delivery material positioned within the at least one void, wherein the coating delivery material is permeable by a coating,
wherein the first aperture, the second aperture and the coating delivery material define a coating passageway through the coating reservoir, and wherein an engagement portion of the coating delivery material defines the narrowest portion of the coating passageway;
at least one support mechanism operably coupled to the coating reservoir; and
at least one drive mechanism configured to translate at least one of the coater and the tube or rod with respect to the other to apply the coating to the exterior surface of the tube or rod when the tube or rod extends through the coating passageway in a coating direction extending at least generally from the second aperture to the first aperture of the coating reservoir,
wherein at least one of the coating delivery material and the at least one support mechanism is configured to support the tube or rod such that when the tube or rod extends through the passageway a portion of the exterior surface of the tube or rod is in contact with the engagement portion of the coating delivery material and not in contact with at least the second aperture of the coating reservoir.

10. The coater of claim 9, wherein the coating delivery material comprises a felt material.

11. The coater of claim 9, wherein when the tube or rod extends through the coating passageway a portion of the outer surface of the tube or rod and an inner surface of the second aperture of the coating reservoir define a substantially annular exit passageway about the tube or rod that substantially defines the thickness of the coating medium applied to the exterior surface of the tube or rod by the coater.

12. The coater of claim 11, wherein the thickness of the substantially annular exit passageway about the tube or rod that substantially defines the thickness of the coating medium applied to the exterior surface of the tube or rod by the coater is within the range of about 200 nanometers to about 10 microns.

13. The coater of claim 11, wherein at least the length of the exit passageway in the coating direction and the drive mechanism are configured such that the coating applied to the exterior surface of the tube or rod is substantially prevented from being exposed to the environment present about the coating mechanism for a predetermined amount of time effective in allowing the applied coating medium to flow and substantially uniformly cover the exterior surface of the tube or rod.

14. The coater of claim 11, wherein the coater includes at least one pump configured to pump the coating medium at a flow rate into the coating reservoir via the at least one port, and wherein at least the length of the exit passageway in the coating direction, the drive mechanism and the flow rate of the at least one pump are configured such that the coating applied to the exterior surface of the tube or rod is substantially prevented from being exposed to the environment present about the coating mechanism for a predetermined amount of time effective in allowing the applied coating medium to flow and substantially uniformly cover the exterior surface of the tube or rod.

15. The coater of claim 9, wherein the coater includes at least one of:
a cleaning mechanism configured to clean the tube or rod before the coating medium is applied to the tube or rod;
a coating treatment mechanism configured to treat the coating medium applied to the tube or rod; and
at least one pump configured to pump the coating medium at a flow rate into the coating reservoir via the at least one port.

16. A method of applying a coating to the exterior surface of an elongate member, the method including:
obtaining a coating mechanism comprising a coating reservoir and at least one support mechanism operably coupled to the coating reservoir, the coating reservoir including:
a first end with a first aperture;
a second end with a second aperture;
at least one void extending between the first and second ends and about the first and second apertures;
at least one port in communication with the at least one void; and
coating delivery material positioned within the at least one void,
wherein the first aperture, the second aperture and the coating delivery material define a coating passageway through the coating reservoir, and wherein an engagement portion of the coating delivery material defines the narrowest portion of the coating passageway;
obtaining an elongate member; and
positioning at least one of the elongate member and the coating mechanism such that the elongate member extends through the coating passageway.

17. The method of claim 16, wherein the method includes translating at least one of the coating mechanism and the elongate member to apply a coating medium to the exterior surface of the elongate member via the coating delivery material in a direction extending at least generally from the second aperture to the first aperture of the coating reservoir.

18. The method of claim 17, wherein at least one of the coating delivery material and the at least one support mechanism is configured to support the elongate member such that when the elongate member extends through the coating passageway a portion of the exterior surface of the elongate member is in contact with the engagement portion of the coating delivery material and the exterior surface of the elongate member is not in contact with at least the second aperture of the coating reservoir.

19. The method of claim 17, wherein translating at least one of the coating mechanism and the elongate member to apply a coating medium to the exterior surface of the elongate member includes translating at least one of the coating mechanism and the elongate member at a first speed that prevents the coating medium applied to the exterior surface of the elongate member from being exposed to the environment present about the coating mechanism for a predetermined amount of time effective in allowing the applied coating medium to flow and substantially uniformly cover the exterior surface of the elongate member.

20. The method of claim 16, wherein the coating mechanism includes at least one pump configured to pump the coating medium into the coating reservoir via the at least one port, and wherein the method includes pumping the coating medium into the coating reservoir at a first flow rate.
